(19) United States
(12) Patent Application Publication
(10) Pub. No.: US 2023/0254156 A1
(43) Pub. Date: Aug. 10, 2023

(54) APPARATUSES, COMPUTER-IMPLEMENTED METHODS AND COMPUTER PROGRAM PRODUCT FOR GRANTING ACCESS TO A CONTROL FUNCTION ON THE BASIS OF AN OBJECT

(71) Applicant: Siemens Aktiengesellschaft, München (DE)

(72) Inventors: Thomas Jetzfellner, Aschheim (DE); Carlos Morra, Berlin (DE)

(21) Appl. No.: 18/011,705

(22) PCT Filed: Jun. 21, 2021
(86) PCT No.: PCT/EP2021/066808

§ 371 Date: Dec. 20, 2022

(30) Foreign Application Priority Data
Jun. 30, 2020 (EP) 20183046.0

(51) Int. Cl. H04L 9/32; H04L 67/12; H04L 9/08; H04L 9/00

(52) U.S. Cl. CPC H04L 9/3247; H04L 67/12; H04L 9/0861; H04L 9/088; H04L 9/50

(57) ABSTRACT

An ecosystem of devices which autonomously interact with one another by a blockchain or a network application is provided. In particular, the provided allows creation of a security-protected data processing of sensor data or measurement data for an object by means of a distributed infrastructure. Fields of application include supply-chain scenarios or industrial control applications of blockchains.

### CROSS-REFERENCE TO RELATED APPLICATIONS

This application claims priority to PCT Application No. PCT/EP2021/066808, having a filing date of Jun. 21, 2021, which claims priority to EP Application No. 20183046.0, having a filing date of Jun. 30, 2020, the entire contents both of which are hereby incorporated by reference.

### FIELD OF TECHNOLOGY

The following relates to methods, apparatuses and a system for the security-protected provision of data sets, the data sets comprising sensor data, for example.

### BACKGROUND

Ever increasing networking of smart devices (e.g. cellular phones, smartwatches) or manufacturing installations is resulting in more and more sensor data being captured by these smart devices and manufacturing installations. In particular, these data are intended to be used to monitor for example manufacture or else transport of objects (e.g., workpieces, foodstuffs, etc.).

EP3435272A1 discloses a method for identifying an additively manufactured workpiece. Aspects of embodiments of the invention are explained below.

### SUMMARY

The technology of blockchains or “distributed ledgers” is currently a technology that is being intensively discussed and that can be realized in particular as a distributed database system or as a network application. Besides applications for decentralized payment systems (e.g., Bitcoin), new application possibilities are being developed in the financial industry. In particular, transactions between companies can be realized by this means without mediators or a clearing house, in a manner protected against manipulation. This enables new business models without a trustworthy mediator, it reduces the transaction costs, and new digital services can be offered in a flexible manner, without the need to set up trust relationships and an infrastructure set up specifically for this. A transaction data set (or transaction for short) protected by a blockchain comprises program code, for example, which can also be referred to as a so-called “smart contract”.

In accordance with one aspect, embodiments of the invention relate to a device for granting access to control functions on the basis of an object, comprising:
a capture module (110) for capturing individual features (M) of an object (O) by means of a capture device (A);
a checking module (120) for calculating a check result on the basis of comparing the individual features with a reference value;
a control module (130) for granting access to control functions, where
   the access to the control functions is effected depending on the check result if the check result confirms a sufficiently accurate match between the reference value and the individual features.

Unless indicated otherwise in the following description, the terms “carry out”, “calculate”, “computer-aided”, “compute”, “ascertain”, “generate”, “configure”, “reconstruct” and the like relate to actions and/or processes and/or processing steps which change and/or generate data and/or convert data into other data, wherein the data can be represented or be present in particular as physical variables, for example as electrical pulses. In particular, the expression “computer” should be interpreted as broadly as possible to cover in particular all electronic devices having data processing properties. Computers can thus be for example personal computers, servers, programmable logic controllers (PLCs), handheld computer systems, pocket PC devices, mobile radio devices and other communication devices which can process data in a computer-aided manner, processors and other electronic devices for data processing.

In association with embodiments of the invention, “computer-aided” can be understood to mean for example an implementation of the method in which in particular a processor performs at least one method step of the method. By way of example, “computer-aided” should also be understood to mean “computer-implemented”. “Computer-implemented” means for example that the method or the method steps thereof is or are carried by one processor or by a plurality of processors.

In association with embodiments of the invention, a “processor” can be understood to mean for example a machine or an electronic circuit. A processor may be in particular a central processing unit (CPU), a microprocessor or a microcontroller, for example an application-specific integrated circuit or a digital signal processor, possibly in combination with a storage unit for storing program instructions, etc. A processor can be, for example, an IC (Integrated Circuit), in particular an FPGA (Field Programmable Gate Array) or an ASIC (Application-Specific Integrated Circuit), or a DSP (Digital Signal Processor) or a GPU (Graphic Processing Unit). A processor can also be understood to mean a virtualized processor, a virtual machine or a soft CPU. It can for example also be a programmable processor, which is equipped with configuration steps for performing the method according to embodiments of the invention mentioned, or is configured with configuration steps such that the programmable processor implements the inventive features of the method, the component, the modules, or other aspects and/or partial aspects of embodiments of the invention.

In association with embodiments of the invention, a “storage unit” or “storage module” and the like can be understood to mean for example a volatile memory in the form of a random-access memory (RAM) or a permanent memory such as a hard disk or a data carrier.

In association with embodiments of the invention, a “module” can be understood to mean for example a processor and/or a storage unit for storing program instructions. By way of example, the processor is specifically designed to execute the program instructions in such a way that the processor executes functions, for implementing or realizing the method according to embodiments of the invention or a step of the method according to embodiments of the invention. A module can for example also be a node of the distributed database system that realizes for example the specific functions/features of a corresponding module. The respective modules can for example also be embodied as separate or independent modules. For this purpose, the corresponding modules can comprise further elements, for example. These elements are for example one or more interfaces (e.g., database interfaces, communication interfaces—e.g., network interface, WLAN interface) and/or an evaluation unit (e.g. a processor) and/or a storage unit. By means of the interfaces, for example, data can be exchanged (e.g., received, communicated, transmitted or provided). By means of the evaluation unit, data can be compared, checked, processed, assigned or calculated for example in a computer-aided manner and/or in an automated manner. By means of the storage unit, data can be stored, retrieved or provided for example in a computer-aided manner and/or in an automated manner.

In association with embodiments of the invention, “comprise”, “have” and the like in particular with regard to data and/or information, can be understood to mean for example (computer-aided) storage of corresponding information and/or of a corresponding datum in a data structure/data set (which e.g., is in turn stored in a storage unit).

In association with embodiments of the invention, “assign”, in particular with regard to data and/or information, can be understood to mean for example a computer-aided assignment of data and/or information. By way of example, a first datum, for this purpose, by means of a storage address or a unique identifier (UID), is assigned a second datum e.g. by the first datum being stored together with the storage address or the unique identifier of the second datum in a data set.

In association with embodiments of the invention, “provide”, in particular with regard to data and/or information, can be understood to mean for example computer-aided providing. The providing is effected for example via an interface (e.g. a database interface, a network interface, an interface to a storage unit). Via said interface, for example, during providing, corresponding data and/or information can be communicated and/or transmitted and/or retrieved and/or received.

In association with embodiments of the invention, “provide” can also be understood to mean for example loading or storing, for example a transaction with corresponding data. This can be done for example on or by a storage module. “Providing” can for example also be understood to mean transferring (or transmitting or communicating) corresponding data from one node to another node of the blockchain or of the distributed database system (or the infrastructure thereof) or of a network application.

In association with embodiments of the invention, a “checksum”, for example a data block checksum, a data checksum, a node checksum, a transaction checksum, a linking checksum or the like, can be understood to mean for example a cryptographic checksum or cryptographic hash or hash value that is formed or calculated in particular by means of a cryptographic hash function by way of a data set and/or data and/or one or more of the transactions and/or a partial area of a data block (e.g. the block header of a block of a blockchain or data block header of a data block of the distributed database system (or of the network application) or only a portion of the transactions of a data block). A checksum can be in particular (a) checksum(s) or hash value(s) of a hash tree (e.g., Merkle tree, Patricia tree). Furthermore, it can also be understood to mean in particular a digital signature or a cryptographic message authentication code. By means of the checksums, at different levels of the database system, for example, it is possible to realize cryptographic protection/protection against manipulation for the transactions and the data (sets) stored therein. If high security is required, for example, the checksums are generated and checked at the transaction level, for example. If the security required is not as high, the checksums are generated and checked for example at the block level (e.g., over the entire data block or only over a portion of the data block and/or a portion of the transactions).

In association with embodiments of the invention, a “data block checksum” can be understood to mean a checksum that is calculated for example over a portion or all transactions of a data block. A node can then check/establish the integrity/authenticity of the corresponding portion of a data block by means of the data block checksum, for example. Additionally or alternatively, the data block checksum may in particular also have been formed over transactions of a preceding data block/predecessor data block of the data block. In this case, the data block checksum can in particular also be realized by means of a hash tree, for example a Merkle tree [1] or a Patricia tree, wherein the data block checksum is in particular the root checksum of the Merkle tree or of a Patricia tree or of a binary hash tree. In particular, transactions are safeguarded by means of further checksums from the Merkle tree or Patricia tree (e.g. using the transaction checksums), wherein in particular the further checksums are leaves in the Merkle tree or Patricia tree. The data block checksum can thus safeguard the transactions for example by the root checksum being formed from the further checksums. The data block checksum can be calculated in particular for transactions of a specific data block of the data blocks. In particular, such a data block checksum can influence a data block succeeding the specific data block in order to link this succeeding data block for example with its preceding data blocks and in particular thus to make an integrity of the distributed database system (or of the network application) checkable. By this means, the data block checksum can for example perform the function of the linking checksum or influence the linking checksum. The header of a data block (e.g. of a new data block or of the data block for which the data block checksum was formed) can comprise the data block checksum, for example.

In association with embodiments of the invention, “transaction checksum” can be understood to mean a checksum which is formed in particular over a transaction of a data block. In addition, for example a calculation of a data block checksum for a corresponding data block can be accelerated since, for this purpose, for example already calculated transaction checksums can be used straightaway as leaves of a Merkle tree, for example.

In association with embodiments of the invention, a “linking checksum” can be understood to mean a checksum which indicates or references in particular a respective data block of the distributed database system (or of the network application) to the preceding data block of the distributed database system (or of the network application) (often referred to as “previous block hash”, in particular, in the technical literature) [1]. For this purpose, a corresponding linking checksum is formed in particular for the corresponding preceding data block. As linking checksum, for example, a transaction checksum or the data block checksum of a data block (that is to say a present data block of the distributed database system or of the network application) can be used to link a new data block with a (present) data block of the distributed database system (or of the network application). However, it is also possible, for example, for a checksum to be formed over a header of the preceding data block or over the entire preceding data block and to be used as linking checksum. This can for example also be calculated for a plurality or all of the preceding data blocks. It is also possible to realize a procedure for example in which the linking checksum is formed over the header of a data block and the data block checksum. However, a respective data block of the distributed database system comprises in each case a linking checksum which was calculated, or refers to, a data block preceding the respective data block, in particular even more the data block directly preceding the respective data block. It is also possible, for example, for a corresponding linking checksum also to be formed only over a portion of the corresponding data block (e.g. preceding data block). As a result, a data block comprising an integrity-protected portion and an unprotected portion can be realized, for example. A data block whose integrity-protected portion is invariable and whose unprotected portion can also still be changed later could thus be realized, for example. In this case, integrity-protected should be understood to mean in particular that an alteration of integrity-protected data is able to be established by means of a checksum.

The data which are stored in a transaction of a data block, for example, can be provided in particular in various ways. Instead of the data, e.g., user data such as measurement data or data/ownership concerning assets, for example a transaction of a data block can comprise only the checksum for these data. In this case, the corresponding checksum can be realized in various ways. This can be e.g., a corresponding data block checksum of a data block (with the corresponding data) of a different database or of the distributed database system or of the network application, a transaction checksum of a data block with the corresponding data (of the distributed database system or of a different database) or a data checksum that was formed over the data.

In addition, the corresponding transaction can also comprise a reference or an indication concerning a storage location (e.g., an address of a file server and indications of where the corresponding data may be found on the file server; or an address of a different distributed database comprising the data). The corresponding data could then for example also be provided in a further transaction of a further data block of the distributed database system (or of the network application) (e.g., if the corresponding data and the associated checksums are comprised in different data blocks). However, it is also conceivable, for example, for these data to be provided via a different communication channel (e.g., via a different database and/or a cryptographically secured communication channel).

Moreover, in addition to the checksum, for example, it is possible to store an additional data set (e.g. a reference or an indication concerning a storage location) in the corresponding transactions, which indicates in particular a storage location where the data can be retrieved. That is advantageous in particular so as to minimize a data size of the blockchain or of the distributed database system (or of the network application).

In association with embodiments of the invention, “security-protected” or “cryptographically protected” can be understood to mean for example protection that is realized by a cryptographic method, in particular. By way of example, this can be realized by use of the distributed database system (or of the network application) for providing or transferring or transmitting corresponding data/transactions. This is achieved by means of a combination of the different (cryptographic) checksums by virtue of the latter interacting synergistically, in particular, in order to improve for example, the security or the cryptographic security for the data of the transactions. In other words, in association with embodiments of the invention, “security-protected” can in particular also be understood to mean “cryptographically protected” and/or “manipulation-protected”, wherein “manipulation-protected” can also be referred to as “integrity-protected”.

In association with embodiments of the invention, “linking (the) data blocks of a distributed database system” can be understood to mean for example that data blocks each comprise information (e.g., linking checksum) that refers to or references one other data block or a plurality of other data blocks of the distributed database system (or of the network application) [1] [4] [5].

In association with embodiments of the invention, “inserting into the distributed database system (or into a network application)” and the like can be understood to mean for example that in particular a transaction or the transactions or a data block with its transactions is/are communicated to one or more nodes of a distributed database system (or of a network application). If these transactions are validated successfully (e.g., by the node(s)), for example, these transactions are linked in particular as a new data block with at least one present data block of the distributed database system (or of the network application) [1] [4] [5]. For this purpose, the corresponding transactions are stored in a new data block, for example. In particular, this validating and/or linking can be effected by a trustworthy node (e.g. a mining node, a blockchain oracle or a blockchain platform). In particular, a blockchain platform can be understood here to mean a blockchain as service, as proposed in particular by Microsoft or IBM. In particular, a trustworthy node and/or a node can in each case store a node checksum (e.g., a digital signature) in a data block (e.g. in the data block generated and validated by them, which is then linked) in order in particular to enable an identifiability of the creator of the data block and/or to enable an identifiability of the node. In this case, said node checksum indicates which node has linked for example the corresponding data block with at least one other data block of the distributed database system (or of the network application).

In association with embodiments of the invention, “transaction” or “transactions” can be understood to mean for example a smart contract [4] [5], a data structure or a transaction data set that comprises in particular in each case one of the transactions or a plurality of transactions. In association with embodiments of the invention, “transaction” or “transactions” can for example also be understood to mean the data of a transaction of a data block of a blockchain. A transaction can comprise in particular a program code that realizes a smart contract, for example. By way of example, in association with embodiments of the invention, transaction can also be understood to mean a control transaction and/or a confirmation transaction. Alternatively, a transaction can be for example a data structure that stores data (e.g., the control commands and/or contract data and/or other data such as video data, user data, measurement data, etc.). In association with embodiments of the invention a “transaction” can for example also be a message or a communication message or be referred to as such. Accordingly, a message, for example, is a transaction, the message for example comprising control commands for controlling the devices and/or else comprising preconditions (e.g., predefined requirements) for executing the control commands.

In particular, “storing transactions in data blocks”, “storing transactions” and the like should be understood to mean direct storing or indirect storing. In this case, direct storing can be understood to mean for example that the corresponding data block (of the distributed database system/of the network application) or the corresponding transaction (of the distributed database system/of the network application) comprises the respective data. In this case, indirect storing can be understood to mean for example that the corresponding data block or the corresponding transaction comprises a checksum and optionally an additional data set (e.g., a reference or an indication concerning a storage location) for corresponding data and, consequently, the corresponding data are not stored directly in the data block (or the transaction) (i.e. instead only a checksum for these data). In particular, when storing transactions in data blocks, it is possible to validate these checksums, for example, as explained for example under “inserting into the distributed database system (or into a network application)”.

In association with embodiments of the invention, a “program code” (e.g., a smart contract or chain code) can be understood to mean for example one program instruction or a plurality of program instructions, which are stored in particular in one or a plurality of transactions. The program code is executable, in particular, and is executed by the distributed database system (or the network application), for example. This can be realized by means of an execution environment (e.g., of a virtual machine), for example, wherein the execution environment and respectively the program code are Turing complete. The program code is executed by the infrastructure of the distributed database system (or of the network application) [4] [5]. In this case, for example, a virtual machine is realized by the infrastructure of the distributed database system (or of the network application).

In association with embodiments of the invention, a “smart contract” (or else chain code) can be understood to mean for example an executable program code [4] [5] (see, in particular, the definition of “program code”). The smart contract is stored in a transaction of a distributed database system (e.g., a blockchain), or of a network application, for example in a data block of the distributed database system or of the network application. By way of example, the smart contract can be executed in the same way as explained in the definition of “program code”, in particular in association with embodiments of the invention.

In association with embodiments of the invention, “smart contract process” or a “smart contract” can be understood to mean in particular also execution of a program code or of a smart contract in a process by the distributed database system or the infrastructure thereof.

In association with embodiments of the invention, “proof-of-work verification” can be understood to mean for example solving a computationally intensive task which is to be solved in particular depending on the data block content/content of a specific transaction [1] [4] [5]. Such a computationally intensive task is for example also referred to as a cryptographic puzzle.

In association with embodiments of the invention, a “network application” can be understood to mean for example a decentralized distributed database, a distributed database system, a distributed database, a peer-to-peer application, a distributed memory management system, a blockchain, a distributed ledger, a distributed storage system, a distributed ledger technology (DLT) based system (DLTS), an audit-proof database system, a cloud, a cloud service, a blockchain in a cloud or a peer-to-peer database. By way of example, a network application can be a distributed database system that is realized e.g., by means of a blockchain (e.g. hyperledger) or a distributed ledger. Moreover, it is possible to use, for example, various implementations of a blockchain or a DLTS, such as e.g., a blockchain or a DLTS implemented by means of a directed acyclic graph (DAG), a cryptographic puzzle, a Hashgraph or a combination of the implementation variants mentioned [6] [7]. Moreover, various consensus methods (referred to as consensus algorithms) can be implemented, for example. This can be for example a consensus method by means of a cryptographic puzzle, gossip about gossip, virtual voting or a combination of the methods mentioned (e.g., gossip about gossip combined with virtual voting) [6] [7]. If a blockchain is used, for example, then this can be implemented in particular by means of a Bitcoin-based realization or an Ethereum-based realization [1] [4] [5]. A “distributed database system” or a “network application” can for example also be understood to mean a distributed database system or a network application of which at least some (or all) of its nodes and/or devices and/or infrastructure are realized by a cloud. By way of example, the corresponding components are realized as nodes/devices in the cloud (e.g., as a virtual node in a virtual machine). This can be effected for example by means of VM-Ware, Amazon Web Services or Microsoft Azure. On account of the high flexibility of the implementation variants explained, in particular partial aspects of the implementation variants mentioned can also be combined with one another, e.g. by using a Hashgraph as a blockchain, wherein the blockchain itself can e.g. also be blockless.

If for example a directed acyclic graph (DAG) is used (e.g. IOTA or Tangle), in particular transactions or blocks or nodes of the graph are connected to one another via directed edges. Acyclic here means, in particular, that there are no directed loops in the graph.

The distributed database system or the network application can be for example a public distributed database system or a public network application (e.g. a public blockchain) or a closed (or private) distributed database system or a closed network application (e.g. a private blockchain).

If a public distributed database system or a public network application is involved, for example, this means that new nodes and/or devices can join the distributed database system or the network application or be accepted thereby without authorization verifications or without authentication or without log-on information or without credentials. In particular, the operators of the nodes and/or devices can remain anonymous in such a case.

If the distributed database system or the network application is a closed distributed database system, for example, new nodes and/or devices require for example a valid authorization verification and/or valid authentication information and/or valid credentials and/or valid log-on information in order to be able to join the distributed database system or the network application or in order to be accepted thereby.

A distributed database system or the network application can also be for example a distributed communication system for data exchange. This can be for example a network or a peer-to-peer network.

A/The distributed database system can for example also be a decentralized distributed database system and/or a decentralized distributed communication system.

A “network application” can for example also be a network application infrastructure or the network application comprises a corresponding network application infrastructure. This infrastructure can comprise for example nodes and/or communication networks and/or data interfaces and/or further components in order to realize or implement the network application. The network application can be e.g. a distributed network application (e.g. a distributed peer-to-peer application or a distributed database system) which is implemented for example on a plurality of nodes of the network application infrastructure.

In association with embodiments of the invention, a “distributed database system”, which can for example also be referred to as a distributed database, can be understood to mean for example a decentralized distributed database, a blockchain, a distributed ledger, a distributed storage system, a distributed ledger technology (DLT) based system (DLTS), an audit-proof database system, a cloud, a cloud service, a blockchain in a cloud or a peer-to-peer database. Moreover, it is possible to use, for example various implementations of a blockchain or a DLTS, such as e.g. a blockchain or a DLTS implemented by means of a directed acyclic graph (DAG), a cryptographic puzzle, a Hashgraph or a combination of the implementation variants mentioned [6] [7]. Moreover, various consensus methods (referred to as consensus algorithms) can be implemented, for example. This can be for example a consensus method by means of a cryptographic puzzle, gossip about gossip, virtual voting or a combination of the methods mentioned (e.g. gossip about gossip combined with virtual voting) [6] [7]. If a blockchain is used, for example, then this can be implemented in particular by means of a bitcoin-based realization or an Ethereum-based realization [1] [4] [5]. A “distributed database system” can for example also be understood to mean a distributed database system of which at least some of its nodes and/or devices and/or infrastructure are realized by a cloud. By way of example, the corresponding components are realized as nodes/devices in the cloud (e.g. as a virtual node in a virtual machine). This can be effected for example by means of VM-Ware, Amazon Web Services or Microsoft Azure. On account of the high flexibility of the implementation variants explained, in particular partial aspects of the implementation variants mentioned can also be combined with one another, e.g. by using a Hashgraph as a blockchain, wherein the blockchain itself can e.g. also be blockless.

If for example a directed acyclic graph (DAG) is used (e.g., IOTA or Tangle), in particular transactions or blocks or nodes of the graph are connected to one another via directed edges. This means, in particular, that (desirably all) edges (desirably always) have the same direction, in a similar manner to time, for example. In other words, it is not possible, in particular, to move or jump to the transactions or the blocks or the nodes of the graph backwards (that is to say in the opposite direction to the same direction shared). Acyclic here means, in particular, that there are no loops when moving through the graph.

The distributed database system can be for example a public distributed database system (e.g. a public blockchain) or a closed (or private) distributed database system (e.g. a private blockchain).

If a public distributed database system is involved, for example, this means that new nodes and/or devices can join the distributed database system or be accepted by the latter without authorization verifications or without authentication or without log-on information or without credentials. In particular, the operators of the nodes and/or devices can remain anonymous in such a case.

If the distributed database system is a closed distributed database system, for example, new nodes and/or devices require for example a valid authorization verification and/or valid authentication information and/or valid credentials and/or valid log-on information in order to be able to join the distributed database system or in order to be accepted by the latter.

A distributed database system can also be for example a distributed communication system for data exchange. This can be for example a network or a peer-to-peer network. Alternatively or additionally, embodiments of the invention can for example also be realized by means of a peer-to-peer application instead of the distributed database system.

In association with embodiments of the invention, “data block”, which can also be referred to as “link” or “block” in particular depending on context and realization, can be understood to mean for example a data block of a distributed database system (e.g. a blockchain or a peer-to-peer database) or of a network application, which in particular is realized as a data structure and comprises in each case one of the transactions or a plurality of the transactions. In one implementation, for example, the database (or the database system) can be a DLT based system (DLTS) or a blockchain and a data block can be a block of the blockchain or of the DLTS. A data block can comprise for example indications concerning the size (data size in bytes) of the data block, a data block header, a transaction counter and one or more transactions [1]. The data block header can comprise for example a version, a linking checksum, a data block checksum, a time stamp, a proof-of-work verification and a nonce (one-off value, random value or counter used for the proof-of-work verification) [1] [4] [5]. A data block can for example also be only a specific storage area or address area of the entire data stored in the distributed database system. It is thus possible to realize for example blockless distributed database systems, such as e.g. the IoT chain (ITC), IOTA, and Byteball. In this case, in particular, the functionalities of the blocks of a blockchain and of the transactions are combined with one another in such a way that e.g. the transactions themselves safeguard the sequence or chain of transactions (of the distributed database system) (that is to say, in particular, are stored in a security-protected manner). For this purpose, with a linking checksum, for example, the transactions themselves can be linked with one another by a separate checksum or the transaction checksum of one or more transactions serving as linking checksum, which is concomitantly stored in the corresponding new transaction when a new transaction is stored in the distributed database system. In such an embodiment, a data block can for example also comprise one or more transactions, wherein in the simplest case for example a data block corresponds to a transaction.

In association with embodiments of the invention, “nonce” can be understood to mean for example a cryptographic nonce (abbreviation of: “used only once” [2] or “number used once” [3]. In particular, a nonce denotes an individual combination of numbers or letters that is used once in the respective context (e.g., transaction, data transfer).

In association with embodiments of the invention, “data blocks preceding a (specific) data block of the distributed database system (or of a network application)” can be understood to mean for example that data block of the distributed database system (or of the network application) which directly precedes in particular a (specific) data block. Alternatively, “data blocks preceding a (specific) data block of the distributed database system” can in particular also be understood to mean all data blocks of the distributed database system (or of the network application) which precede the specific data block. As a result, by way of example, the linking checksum or the transaction checksum can be formed in particular only over the data block (or the transactions thereof) directly preceding the specific data block or over all data blocks (or the transactions thereof) preceding the first data block.

In association with embodiments of the invention, a “blockchain node”, “node”, “node of a distributed database system or of a network application” and the like can be understood to mean for example devices (e.g., field devices, cellular phones), computers, smartphones, clients or subscribers that carry out operations with the distributed database system (e.g., a blockchain) [1] [4] [5]. Such nodes can for example execute transactions of a network application or of a distributed database system or the data blocks thereof or introduce or link new data blocks with new transactions into the distributed database system (or into the network application) by means of new data blocks. In particular, this validating and/or linking can be effected by a trustworthy node (e.g. a mining node) or exclusively by trustworthy nodes. A trustworthy node is for example a node that has additional security measures (e.g., firewalls, access restrictions to the node or the like) in order to prevent a manipulation of the node. Alternatively or additionally, by way of example, during the linking of a new data block with the distributed database system, a trustworthy node can store a node checksum (e.g. a digital signature or a certificate) in the new data block. A verification can thus be provided, in particular, which indicates that the corresponding data block was inserted by a specific node or indicates its origin. The devices (e.g., the corresponding device) are for example devices of a technical system and/or an industrial installation and/or an automation network and/or a manufacturing installation which in particular are also a node of the distributed database system (or of the network application). In this case, the devices can be for example field devices or devices in the Internet of Things which in particular are also a node of the distributed database system (or of the network application). Nodes can for example also comprise at least one processor in order to carry out e.g. their computer-implemented functionality. A node can be embodied as a device, for example, or a node can comprise a device, for example.

In association with embodiments of the invention, a “blockchain oracle” and the like can be understood to mean for example nodes, devices or computers that have e.g. a security module comprising for example software protection mechanisms (e.g. cryptographic methods), mechanical protection devices (e.g. a lockable housing) or electrical protection devices (e.g. tamper protection or a protection system that erases the data of the security module in the event of impermissible use/handling of the blockchain oracle) or a combination of the possibilities mentioned. In this case, the security module can comprise cryptographic keys, or a secret (e.g. a character string) for example, which are necessary for calculating the checksums (e.g. transaction checksums or node checksums).

In association with embodiments of the invention, a “computer” or a “device” can be understood to mean for example a computer (system), a client, a smartphone, an IoT device, a device or a server, each of which is arranged outside the blockchain and is not part of the infrastructure of the distributed database system (or of the network application) or forms a separate isolated infrastructure. A device is for example a manufacturing device and/or an electromechanical device and/or an electronic device and/or a device of an automation network (e.g. for industrial technological installations, manufacturing installations, energy or resource distribution installations); in particular, these devices are not able to communicate directly with the distributed database system (directly) or the network application.

Such a device outside the distributed database system (or the network application) cannot access the data of the distributed database system (or of the network application), for example, since the device is too old, for example, and neither has the necessary cryptographic and/or IT security capabilities nor is compatible with the data format of the distributed database system (or of the network application).

A device can for example also be a node of a network application or of a distributed database system.

In association with embodiments of the invention, a “separate and/or direct communication channel” can for example be understood to mean data transfer (e.g. transmitting, receiving, transferring, providing or communication), by means of a communication channel. By way of example, via this channel, it is possible to send transactions/messages more rapidly and to store a confirmation about this data exchange in the distributed database system. Thus, for example, important and/or time-critical transactions or messages (e.g. control commands or control transactions) can be transferred at higher speed to a corresponding target (e.g. a device) and e.g. the slower data transfer of the distributed database system (e.g. in the case of the replication of the data blocks/transactions can be avoided in the process. By way of example, for embodiments of the invention and the stated aspects, exemplary embodiments, embodiments of the invention and their variants, a separate and/or direct communication channel can be established for a data transfer between a device (and/or node). By way of example, in the case of a direct communication channel, the transactions/messages are exchanged directly between a transmitter (e.g. the (first) device) and a receiver/target (e.g. the device that is intended to execute, process or evaluate the control commands), without further nodes and/or devices of the distributed database system being involved in this data exchange. By contrast, in the case of a separate communication channel, nodes and/or devices of the distributed database system can be involved in the data exchange, for example. If the separate and/or direct communication channel was successfully established between the transmitter and the receiver (that is to say that in particular a communication connection was established as a result), then data for example in the form of transactions or messages can be exchanged between the transmitter and the receiver. If for example the communication channel is closed/ended (that is to say that in particular a communication connection is ended), then for example a result of the data transfer e.g. in the form of transactions (e.g. as a transfer confirmation transaction or confirmation transaction) is stored in the distributed database system (e.g. in data blocks of the distributed database system). The result of the data transfer can be for example a confirmation of the transfer or of the reception of the corresponding transactions/messages and/or an analysis result and/or the last transferred transaction/message that was transferred via the separate and/or direct communication channel before the communication channel was closed. The storage of the transaction with the result can be effected by the transmitter and/or receiver, for example. The analysis result can be for example the confirmation of the reception of the message/transaction and/or that the message/transaction and e.g. the control commands thereof can be processed by the target/receiver (e.g. a confirmation of the executability by the target). This can for example in turn be stored in a transaction (e.g. in an executability confirmation transaction). Alternatively or additionally, the executability confirmation transaction is stored in the distributed database system. In this case, the executability confirmation transaction comprises for example a unique identifier for the device that is able to execute the control commands, and/or can indicate for example when the control commands of the message/transaction are executed at the latest. Alternatively or additionally, the executability confirmation transaction comprises for example data regarding the execution, e.g. how well or to what degree the control commands are processed (e.g. how rapidly the control commands are processed, when the latter are securely processed, how accurately or precisely the control commands are executed—for example when executing manufacturing control commands in order e.g. to document processing of a workpiece).

Alternatively or additionally, the executability confirmation transaction comprises for example device-specific data (e.g. type of device; current device state such as e.g. ready for operation, maintenance necessary, fault state of the corresponding device; serial number of the device; location of the device; a checksum/hash of the executed control commands that was calculated for example with the aid of embodiments of the stated invention; tools used; materials used, or a combination of the stated data) of the corresponding device (e.g. of the target/receiver) which are relevant to the execution of the control commands, wherein e.g. the device-specific data were ascertained by the corresponding device at the time of the confirmation of executability by the device. In this case, e.g. the confirmation of the executability and the ascertainment of the device-specific data are effected (approximately) at the same time—for example within a time window of a few seconds or minutes. By way of example, the data of the executability confirmation transaction may also have been exchanged between the transmitter and the receiver before the executability confirmation transaction is stored e.g. in the distributed database system. The executability confirmation transaction can for example also be cryptographically protected (e.g. it can be encrypted or be protected by a transaction checksum). Moreover, for example, the last message exchanged via the communication channel can be stored in the transfer confirmation transaction (e.g. if the communication channel is interrupted) and the transfer confirmation transaction can e.g. then be stored in the distributed database system. Said last message exchanged can be used for example to continue the data exchange or the data transfer in the event of renewed establishment of the communication channel. The transfer confirmation transaction can for example also be cryptographically protected. The transfer confirmation transaction can comprise for example the control commands and/or the control transaction and/or the last message exchanged between the transmitter and the receiver. A continuation of the data exchange or of the data transfer can for example also be used for other data transfers and is not specifically restricted to the data transfer or the data exchange of a single message.

The separate and/or direct communication channel is advantageous to the effect of improving a transfer speed and/or transfer latency. A hybrid method is also possible, for example, where for example a corresponding communication channel is used for time-critical control commands (e.g., with high or critical priority). By way of example, on the basis of the execution requirements (e.g., time-critical control commands are priority control commands for a real-time application), it is possible to determine whether the control commands are corresponding control commands which are intended to be transferred via a corresponding separate communication channel and/or direct communication channel. Alternatively or additionally, the determining module, for example, when determining the message control data set, can determine corresponding instructions for a data transfer of the message.

In association with embodiments of the invention, an “object” can be understood to mean for example a physical object, physical goods, a workpiece (e.g. a motor part or an engine part or an electronic component, or a printed circuit board with electronic components), an intermediate product in manufacture, raw materials (e.g. diamonds, petroleum), food (e.g. milk or bananas) or devices (e.g. electrical devices, electromechanical devices, IoT devices, electronic devices or mechatronic devices).

In association with embodiments of the invention, “individual features” (or e.g. referred to only as features) can be understood to mean for example features (e.g. in the form of data) which can be captured by a sensor from or via the object and can correspond for example to a physical variable (e.g. wavelength of light). In this case, the individual features are for example object-specific features, that is to say e.g. that these features or data correspond to a unique combination of a sequence of ones and zeros (digital fingerprint or a type of unique identifier) in the form of binary coded data which can be fixedly assigned e.g. to a corresponding object or to the object. The individual features can be for example surface features (e.g. scratches, surface unevennesses) of the object. Alternatively or additionally, the individual features can be e.g. spectroscopic data (which can e.g. also be referred to as spectral data) about the object (e.g. measured spectra, hyper spectral images). By way of example, the object can be gemstones, crude oil or food, of which a spectrum for the object or a predefined position (e.g. a predefined area and/or position) of the object is captured e.g. by means of a capture device in the form of a spectroscope. In this respect, the individual features can be for example spectroscopic individual features. The individual features can for example also be features which e.g. are not able to be removed from the object without damaging or changing the object in the process. Corresponding features can be referred to for example as intrinsic individual features of the object.

The individual features can for example also be individual features of a noise signal captured e.g. by the capture device (e.g. an oscilloscope). If the object is an electronic component, for example, then an object-specific noise signal or an object-specific signal (e.g. a signal generator that generates an invariable specific signal that is configurable once, for example) can be captured for example via an interface of the object. With this noise signal, it is possible to capture and/or take account of the amplitude of the noise signal for specific resistances and/or damping levels, for example. Moreover, by way of example, a predefined test signal can be provided by the object and signal distortions for the individual features can optionally be taken into account in this case. Alternatively or additionally, by way of example, the capture device can transmit a test signal that is transferred/transmitted e.g. by predefined circuits of the object. By way of example, the object or the corresponding circuits of the object generate(s) a response comprising the test signal, for example, the response being communicated to the capture device. By way of example, the individual influence of the circuits on the test signal is then captured as the individual features by the capture device. This individual influence can be for example a distortion of the test signal. Accordingly, the individual features can be for example individual electronic features. Moreover, by way of example, the individual features can be acoustic features of the object (e.g. motor/engine noises, operating noises). In order that the capture device can capture the individual features as easily as possible, for example, the manner and location (e.g. can be referred to as configuration) on the object are predefined by an object data set, for example. This object data set can be provided for example by the network application or a database (e.g. a distributed database system) or this object data set is retrievable for the capture module or for the capture device from the object by means of a data memory attached to the object. The object can for example also comprise the data memory. In this case, the object data set can comprise for example information about the type of measurement (e.g. optical, spectral, acoustic, electrical, optoacoustic, multispectral optoacoustic), the type of sensor (e.g. microphone, ultrasonic sensor, infrasonic sensor, spectral measuring systems, optoacoustic measuring systems, optoacoustic measuring systems), the location, the period of time and the measuring parameters (e.g. damping; signal filters such as high pass, low pass, bandpass, frequencies, wavelengths) to be implemented in order to capture the individual features.

In particular, when capturing and/or evaluating and/or comparing and/or checking and/or processing the individual features, tolerance values can be taken into account in order e.g. to compensate for measurement tolerances or measurement inaccuracies, e.g. of the capture device.

Alternatively, by way of example, for objects of identical type (e.g. workpieces of the same type), the corresponding information necessary for capturing the individual features can be fixedly predefined. By way of example, in the case of an object in the form of a workpiece, the underside of the object is captured or markings are attached to the object, for example, in order that the object finds the corresponding positions on the object and can capture the individual features. This fixedly predefined information can for example be stored for objects correspondingly of identical type in a network application or a database system (e.g. the distributed database system) or be fixedly preconfigured in corresponding devices.

In association with embodiments of the invention, an “object-specific characteristic” (or e.g. referred to only as characteristic) can be understood to mean for example processed (e.g. by data processing) individual features, which in this case are processed in particular in such a way that the individual characteristic is able to be generated reproducibly for the same individual features. In particular, tolerance values can be taken into account here in order e.g. to compensate for measurement tolerances or measurement inaccuracies of the capture device. The object-specific characteristic is for example a digital fingerprint for the object. The digital fingerprint is calculated for example by means of an algorithm for digital fingerprints (e.g. Rabin's fingerprinting algorithm). If the individual features are for example a signal or a noise signal, then the signal-to-noise ratio, the phase of the signal, frequencies, wavelength information, frequency amplitudes can be used. Moreover, for example, the individual features can be evaluated e.g. with regard to wavelengths and amplitudes in the case of spectra. In the case of hyper spectral images, for example, the intensity of the wavelength at one or more image positions or positions on the object (or in the corresponding captured images) can be evaluated for the respective wavelengths of the images.

Before the corresponding characteristic is calculated for the corresponding individual features, for example, it is possible e.g. to preprocess the individual features in order to compensate for the measurement inaccuracies. By way of example, measurement values of the individual features lie in a possible value range (e.g. 1 to 100). This value range is divided for example into predefined intervals, e.g. 5 value intervals (1-20, 21-40, 41-60, 61-80, 81-100). The individual value intervals are then allocated interval-specific values (e.g. 1-20: A, 21-40: B, 41-60: C, 61-80: D, 81-100: E). By way of example, if a measurement value of the individual features is evaluated or preprocessed, then e.g. the value interval in which the specific measurement value lies is checked and the interval-specific value is used for the calculation of the digital fingerprint. For the values 1 and 100, for example, “AE” would be the result. Other methods can also be used, for example. These are for example mean value methods or moving average methods. The corresponding possibly preprocessed individual features are then used e.g. as input parameters for an algorithm for calculating the digital fingerprint. Alternatively or additionally, by way of example, one of the aforementioned preprocessing/processing variants can be applied to the data (individual features and/or object-specific features) which are used to ascertain or provide or calculate the first cryptographic key. Alternatively, by way of example, it is possible to use the explained preprocessing/processing for the corresponding data (e.g. the individual features and/or object-specific features and/or object-specific characteristic) before these are also used for other purposes. By way of example, the cryptographic checksum can be calculated on the basis of these data processed in this way, by virtue of these data being used e.g. as a secret when calculating the cryptographic checksum (e.g. this can be used for the device).

In association with embodiments of the invention, “messages” can be understood to mean for example messages of a communication protocol and/or transactions of a database system (e.g. of a distributed database system) or of a network application. By way of example, a message can correspond to the data structure or a message can comprise the data structure. The corresponding message can for example also comprise the corresponding cryptographic checksum.

In association with embodiments of the invention, a “data structure” can be understood to mean for example a message or a transaction. Alternatively, by way of example, a message or a transaction comprises a corresponding data structure. By way of example, the data structure, the message or the transaction optionally comprises a corresponding cryptographic checksum for the data structure.

In association with embodiments of the invention, a “cryptographic key” can be understood to mean for example a symmetric cryptographic key or a private key of an asymmetric cryptographic key pair or a public key of an asymmetric cryptographic key pair.

By way of example, a data structure used by embodiments of the invention can comprise even further data, such as control commands, for example, in order to control e.g. further transport or further processing of the object, if e.g. it was ascertained by way of embodiments of the invention that the object is authentic or corresponds to the object for which e.g. a corresponding data structure (with a checksum) had already been stored e.g. in the network application.

Embodiments if the invention make it possible, in particular, to realize a decentralized infrastructure (e.g., blockchain-based) which manages real or physical goods (e.g. objects) by means of a digital infrastructure and the processing of which (e.g. manufacturing, transport and confirmation of the authenticity thereof) is controlled. Furthermore, specific services can be provided, for example, if a corresponding object with which these services are associated is present. These services can be controlled or released by means of the control functions, for example.

Frequently, by way of example, physical objects are assigned a (digital) service or a corresponding physical object is intended to utilize a corresponding service (e.g. in the form of control functions provided), in order e.g. to control the further processing of a/the object (e.g. of a workpiece) and/or to document its transport and work steps.

Embodiments of the invention allow, in particular for a (physical) object, corresponding control functions to be provided in order to use corresponding (digital) services. If the allowed control functions are identified for the object, for example, then it is possible for example to exchange data between the object and e.g. a network application by way of a corresponding control function. In the data structure, it is then possible e.g. to communicate data about the state of the object (e.g. a device state if the object is a device—such as e.g. ready for operation, maintenance necessary, fault state of the corresponding device) and/or to request further required control functions e.g. at the network application. By way of the control functions, it is then possible e.g. to perform software updates of the object or to perform software updates of other objects or systems, wherein the object in this case enables e.g. the control functions necessary for this.

By way of example, if a corresponding object is delivered or it is intended to be processed or treated, then there is e.g. a need or a necessity to be able to check what control functions are available for the corresponding object.

In order to achieve this objective, by way of example, the individual features of the object are captured by the capture device and compared with the corresponding reference value or checked. The individual features can be for example surface structures of the object if the object is for example a workpiece that was manufactured by means of machining. In this case, by way of example, the individual features can be captured at predefined positions of the object by the capture device (e.g. a surface capture device such as, for example, a 3D surface scanner or a surface camera), wherein in such a case, for example, the individual features are individual surface features of the object. It is also conceivable, for example, that a digital fingerprint in the form of the individual features was incorporated into the object. This fingerprint or the digital features cannot be ascertained for example with the naked eye and/or without knowledge of the type and position or can be ascertained only with considerable technical outlay. Accordingly, by way of example, the information for capturing the individual features can be stored in a protected memory of the device, such that this information cannot be accessed by unauthorized persons. The incorporated fingerprint can be for example surface unevennesses produced during the manufacture of the object. Alternatively or additionally, the fingerprint can be realized by applying colors or particles, wherein for example the colors or particles are applied in such a way that an individual spectrum is generated for the object. For this purpose, by way of example, different colors/particles can be distributed over the surface of the object, such that for example a geometric spectrum is generated in order that a predefined spectrum can be measured e.g. at specific positions of the object. The spectrum or the colors/particles are chosen for example in such a way that they do not lie in the spectrum that is visible to the human eye. This can be for example a spectrum that lies beyond 800 nm (e.g. wavelengths >800 nm such as a wavelength range of between 800 nm and 1000 nm).

The individual features can for example also be features other than surface features. By way of example, the individual features can be spectroscopic data about the object. By way of example, the object can be gemstones, crude oil or food, of which a spectrum for the object or a predefined position (e.g. a predefined area and/or position) of the object is captured e.g. by means of a capture device in the form of a spectroscope. In this respect, the individual features can be spectroscopic individual features, for example. The individual features can for example also be individual features of a noise signal, captured e.g. by the capture device (e.g. an oscilloscope). If the object is an electronic component, for example, then an object-specific noise signal or an object-specific signal (e.g. a signal generator that generates an invariable specific signal that is configurable once, for example) can be captured for example via an interface of the object. With this noise signal, it is possible to capture and/or take account of the amplitude of the noise signal for specific resistances and/or damping levels, for example. Moreover, by way of example, a predefined test signal can be provided by the object and signal distortions for the individual features can optionally be taken into account in this case. Alternatively or additionally, by way of example, the capture device can transmit a test signal that is transferred/transmitted e.g. by predefined circuits of the object. By way of example, the object or the corresponding circuits of the object generate(s) a response comprising the test signal, for example, the response being communicated to the capture device. By way of example, the individual influence of the circuits on the test signal is then captured as the individual features by the capture device. This individual influence can be for example a distortion of the test signal. Accordingly, the individual features can be for example individual electronic features.

Depending on the object and/or a corresponding configuration/definition, the individual features can thus be for example individual surface features and/or individual spectroscopic features and/or individual electronic features. The individual features can for example also be acoustic features, optoacoustic features or multispectral optoacoustic features. The corresponding individual features can be captured reproducibly for the object, for example.

The individual features (e.g. can also be referred to as object-specific features) can for example also be a combination of the aforementioned examples for individual features.

Using the individual features, an object-specific characteristic, for example, can then be calculated. In this case, for example, tolerance values for the individual features can be taken into account in order for example to generate a reproducible object-specific characteristic for the object. The object-specific characteristic is advantageous to the effect of compensating for measurement inaccuracies when capturing the individual features, for example.

By way of example, the data structure mentioned can be a message or a message can comprise the data structure, wherein the message is intended to be stored or processed for example by a distributed database system or a network application, wherein the distributed database system or the network application is for example a blockchain and the data structure is a transaction of the distributed database system (or of the network application) and the cryptographic checksum is for example a transaction checksum. By way of example, the cryptographic checksum is appended to the data structure, such that the integrity and/or origin and/or authenticity of the data structure and the association thereof with the object can be checked.

In this case, the network application or a database can comprise a multiplicity of reference values, for example, to which e.g. the corresponding (allowed) control functions (e.g. write functions and/or access restrictions) for a corresponding object are assigned. By way of example, which of the control functions are available or can be provided when the object is present is identified by means of comparing and/or determining the check result on the basis of the individual features with the reference value.

In this context, providing means, for example, that the control functions assigned to the object or to the corresponding reference value are accessed by e.g. communication of access data corresponding to the device or to the object for the control functions (e.g. a web service) (e.g. via a communication connection). The access data are usable in a time restricted manner in order to ensure that these data cannot be used for an unnecessary long period of time e.g. in the absence of the object.

In a first embodiment of the device, the device comprises a cryptography module, for example, wherein the cryptography module calculates for example a first cryptographic key on the basis of an object-specific characteristic and/or on the basis of the individual features.

In further embodiments of the device, the individual features are compared with the corresponding reference value, wherein in the case of a sufficiently accurate match between the reference value and the individual features, the first cryptographic key and/or access data are released by the cryptography module. Alternatively or additionally, for example, the access to the corresponding control functions can be effected by way of the first cryptographic key and/or by means of the access data. By way of example, a corresponding request message (realized e.g. as a corresponding data set or data structure in a message) can be cryptographically signed using the first cryptographic key. If e.g. correctness of the corresponding digital signature was able to be confirmed by way of checking by means of a corresponding assigned further cryptographic key or assigned key material (e.g. provided by a trustworthy entity such as a trustworthy server or a certificate authority) e.g. the corresponding control functions are provided or access thereto is granted.

In further embodiments of the device, a communication connection is set up between the object and/or device. Alternatively or additionally, a communication connection is set up between the object and/or a network application. Alternatively or additionally, a communication connection is set up between the object and/or the device and/or a network application.

In further embodiments of the device, the communication connection is protected by means of cryptographic protection.

In further embodiments of the device, the cryptographic protection can be generated and/or checked and/or removed with the first cryptographic key.

In further embodiments of the device, the reference value is a reference hash value or a unique (reference) identifier, wherein for example the reference hash value or the unique (reference) identifier was formed for a or the stored reference value. Alternatively or additionally, the individual features are an object hash value or a unique (object) identifier, wherein the object hash value or the unique (object) identifier was or is formed during capture of the individual features (e.g. on the basis of the captured individual features), for example. By way of example, corresponding (cryptographic) functions can be used for calculating the corresponding hash values or the corresponding unique identifiers.

In further embodiments of the device, the reference value is defined during production of the object, wherein the reference value is assigned to the object in particular during production thereof.

In further embodiments of the device, the control functions allow access to a database or network application in order to exchange or synchronize data about the object in a data structure with the database or the network application.

In further embodiments of the device, the control functions are corresponding control functions of the device and/or corresponding control functions of the object and/or corresponding control functions of a network application.

In further embodiments of the device, the network application or the distributed database system is for example a blockchain, where
the device is embodied for example as a node or an oracle of the distributed database system or of the network application,
the cryptographic checksum is for example a digital signature.

In further embodiments of the device, the device comprises a calculation module (120), for example, wherein
the calculation module (120) is designed for example for calculating an object-specific characteristic on the basis of the individual features,
the characteristic is calculated for example taking account of predefined tolerance values of the individual features,
for example the characteristic and/or the individual features are/is compared with the corresponding reference value,
for example in the case of a sufficiently accurate match between the reference value and the characteristic and/or the individual features, the first cryptographic key is released by the cryptography module.

In further embodiments of the device, the device comprises a monitoring module, for example, wherein for example the monitoring module is designed to monitor the device and in particular to store information of the monitoring in a file or in a data structure. It is thus possible to monitor the operation of the device and e.g. to ascertain when changes were made to a device (e.g. a software or firmware update was installed) or when a device state of the device changed, for example.

In further embodiments of the device, the object and/or the device comprise(s) an object data set, wherein,
the object data set indicates at what geometric locations and/or interfaces the capture device can capture the individual features,
the object data set comprises for example the individual features and/or the object-specific characteristic in encrypted form,
for example the encrypted individual features and/or object-specific characteristic can be decrypted by means of the first cryptographic key,
the object data set comprises for example further object data such as, for example, measurement values of the object, measurement values about the object, production indications of the object, whereabouts of the object,
the further object data are captured for example by sensors of the device for the object,
the sensors are for example a GPS module and/or temperature sensors and/or optical sensors which capture for example corresponding properties of the object.

The device is advantageous to the effect of defining for example specific selected regions of the object or else the interfaces via which the individual features can be captured by the capture device. The interfaces can be for example interfaces of the object if for example the object is an electronic component. For this purpose, the object data set can for example be stored in a corresponding data structure and be exchanged between the object and/or the device and/or the network application.

In a further embodiment of the device, the object-specific characteristic is calculated taking account of predefined tolerance values of the individual features.

The device is advantageous to the effect of compensating for measurement inaccuracies when calculating the characteristic, for example, in order to calculate the object-specific characteristic for the correct object, optionally in a reproducible manner. By way of example, the tolerance values can be chosen in such a way that, in the case of spectroscopic individual features (also called spectral individual features) of an object, e.g. in the form of food, no first cryptographic key is provided (or no valid first cryptographic key can be provided) if the object or the food is no longer fresh enough. By way of example, if the object is bananas, then the tolerance value for the spectrum of the surfaces of the bananas can be chosen in such a way that when the bananas turn brown over a large area (e.g. there is a significantly reduced green component and/or yellow component in the spectrum, such that e.g. a corresponding reference value is undershot), no first cryptographic key is provided (or no valid first cryptographic key can be provided) for these bananas. Accordingly, at a transport point or at an intermediary, the bananas or a banana delivery with these bananas can no longer be confirmed/stored as “fresh” in a supply chain by means of a message with the data structure or the data structure in the distributed database system (or in the network application). In the same way, for example, other objects in the form of perishable goods can be monitored by means of messages/data structures in a distributed database system (or in a network application). The corresponding tolerance values are then chosen accordingly so that, if appropriate, no first cryptographic key is provided if the perishable goods have degenerated e.g. too much (e.g. the shelf life of food has expired or the food has spoiled). Alternatively, if the tolerance values are exceeded, for example, an alternative cryptographic key can be provided, on the basis of which it is possible to test the point in the documentation of the transport of the object at which the tolerance values were exceeded. In other words, by means of the tolerance values, for example, it is possible to define a threshold value, upon the exceeding of which in particular no corresponding valid first cryptographic key is provided or no valid cryptographic checksum is created. In particular, in such a case, e.g. a tolerance value can correspond to a threshold value.

In further embodiments of the device, the first cryptographic key is calculated for example on the basis of the object-specific characteristic and/or the individual features and/or a character string. Alternatively, the cryptographic checksum, for example, can be calculated instead of the first cryptographic key, for example.

In a further embodiment of the device, a predefined tolerance value is taken into account when comparing the individual features with the corresponding reference value.

The device is advantageous to the effect of taking into account measurement inaccuracies when capturing the individual features, for example, in order to calculate the specific features for the correct object, optionally in a reproducible manner. By way of example, the tolerance values can be chosen in such a way that, in the case of spectroscopic individual features (also called spectral individual features) of an object, e.g. in the form of food, no first cryptographic key is provided (or no valid first cryptographic key can be provided) if the object or the food is no longer fresh enough. By way of example, if the object is bananas, then the tolerance value for the spectrum of the surfaces of the bananas can be chosen in such a way that when the bananas turn brown over a large area (e.g. there is a significantly reduced green component and/or yellow component in the spectrum, such that e.g. a corresponding reference value is undershot), no first cryptographic key is provided (or no valid first cryptographic key can be provided) for these bananas. Accordingly, at a transport point or at an intermediary, the bananas or a banana delivery with these bananas can no longer be confirmed/stored as “fresh” in a supply chain by means of a message with the data structure or the data structure in the distributed database system (or in the network application). In the same way, for example, other objects in the form of perishable goods can be monitored by means of messages/data structures in a distributed database system (or in a network application), by, for example, storing corresponding information in the network application. The corresponding tolerance values are then chosen accordingly so that, if appropriate, no first cryptographic key is provided if the perishable goods have degenerated e.g. too much (e.g. the shelf life of food has expired or the food has spoiled). Alternatively, if the tolerance values are exceeded, for example, an alternative cryptographic key can be provided, on the basis of which it is possible to test the point in the documentation of the transport of the object at which the tolerance values were exceeded. In other words, by means of the tolerance values, for example, it is possible to define a threshold value, upon the exceeding of which in particular no corresponding valid first cryptographic key is provided or no valid cryptographic checksum is created. In particular, in such a case, e.g. a tolerance value can correspond to a threshold value.

In further embodiments of the device, the object data set comprises data which indicate at which geometric locations and/or interfaces the capture device can capture the individual features.

The device is advantageous to the effect of defining for example specific selected regions of the object or else the interfaces via which the individual features can be captured by the capture device. The interfaces can be for example interfaces of the object if the object is an electronic component, for example.

In further embodiments of the device, the object data set comprises for example the individual features and/or the object-specific characteristic in encrypted form, wherein for example the encrypted individual features and/or the object-specific characteristic can be decrypted by means of the first cryptographic key.

The device is advantageous to the effect of, for example, making the characteristic checkable by a recipient (e.g. in the sense of a delivery of goods) in order e.g. to ascertain the extent to which the individual features and/or the object-specific characteristic have varied during the processing of the object. This is relevant for example if the object was transported over a long transport route or a plurality of production steps were carried out during the production of the object. In these aforementioned cases and other cases, a data structure is created for the object and stored for example in a distributed database system (or in a network application) (as already explained above, for example). In this case, for example, the data structure can additionally comprise information about the manufacturing step, manufacturing conditions (temperatures during manufacture), tools used and materials used. In the case of transport, the data structure can comprise for example, information about the transport conditions (temperature for cold chains, position information, etc.). This additional information can be referred to as further object-related data, for example. By way of example, in the case of transport, the object can be a transport container comprising corresponding sensors and/or the device. The transport container can be for example transport containers for milk, gemstones or other foods/materials. The transport container could comprise for example a device according to embodiments of the invention and a corresponding capture device.

In further embodiments of the device, the object data set comprises for example further object-related data, such as, for example, measurement values of the object, measurement values about the object, production indications of the object, whereabouts of the object, wherein the further object data are captured for example by sensors of the device for the object or by sensors of the object, wherein the sensors are for example a GPS module and/or temperature sensors and/or optical sensors and/or acoustic sensors and/or optoacoustic sensors which capture corresponding properties of the object, for example.

By way of example, the sensor values can be captured during manufacture or during transport of the object and e.g. be stored in the distributed database system (or in the network application) or processed (e.g. by control functions such as e.g. a service) (e.g. by means of the data structure in conjunction with the cryptographic checksum).

In accordance with a further aspect, embodiments of the invention relates to a computer-implemented method for granting access to control functions on the basis of an object, comprising the following method steps:
capturing individual features (M) of an object (O) by means of a capture device (A);
calculating a check result on the basis of comparing the individual features with a reference value,
granting access to control functions, wherein
   the access to the control functions is effected depending on the check result if the check result confirms a sufficiently accurate match between the reference value and the individual features.

In further embodiments of the method, the method comprises further method steps in order to realize the functional features or further features of the device or the embodiments thereof.

Furthermore, a computer program product (non-transitory computer readable storage medium having instructions, which when executed by a processor, perform actions) comprising program instructions for carrying out the mentioned methods according to embodiments of the invention is provided, wherein in each case one of the methods according to embodiments of the invention, all of the methods according to embodiments of the invention or a combination of the methods according to embodiments of the invention can be carried out by means of the computer program product.

In addition, a variant of the computer program product comprising program instructions for the configuration of a creating device, for example a 3D printer, a computer system or a production machine suitable for creating processors and/or devices, is provided, wherein the creating device is configured with the program instructions in such a way that the stated device according to embodiments of the invention is created.

Furthermore, a providing apparatus for storing and/or providing the computer program product is provided. The providing apparatus is a data carrier, for example, which stores and/or provides the computer program product. Alternatively and/or additionally, the providing apparatus is for example a network service, a computer system, a server system, in particular a distributed computer system, a cloud-based computer system and/or virtual computer system which stores and/or provides the computer program product in the form of a data stream.

This providing is effected for example as a download in the form of a program data block and/or instruction data block, as a file, in particular as a download file, or as a data stream, in particular as a download data stream, of the complete computer program product. However, this providing can also be effected as a partial download, for example, which consists of a plurality of parts and in particular is downloaded via a peer-to-peer network or is provided as a data stream. Such a computer program product is read into a system for example using the providing apparatus in the form of the data carrier and executes the program instructions, such that the method according to embodiments of the invention is caused to be executed on a computer or configures the creating device in such a way that it creates the device according to embodiments of the invention.

### BRIEF DESCRIPTION

Some of the embodiments will be described in detail, with reference to the following figures, wherein like designations denote like members, wherein:

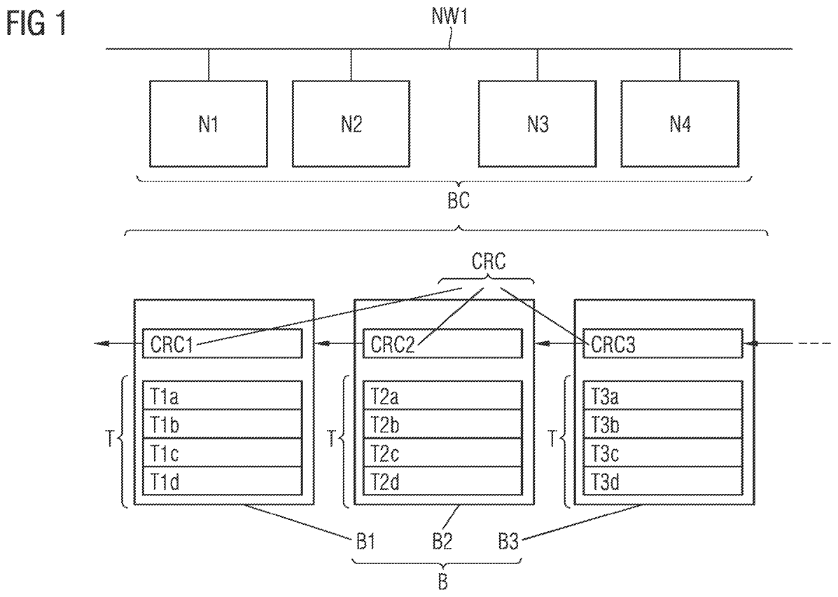

FIG. 1 shows a first exemplary embodiment of the invention;

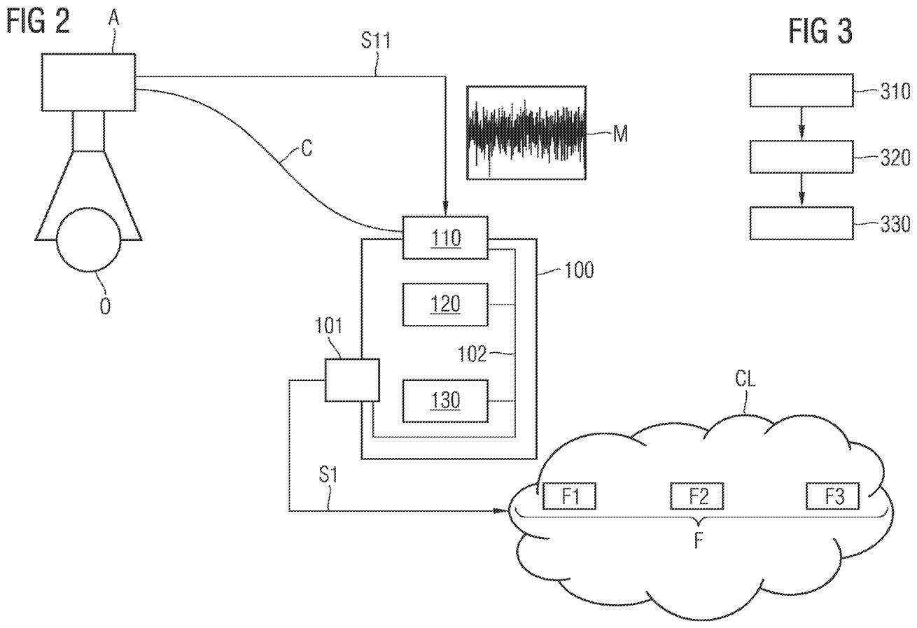

FIG. 2 shows a further exemplary embodiment of the invention; and

FIG. 3 shows a further exemplary embodiment of the invention.

In the figures, functionally identical elements are provided with the same reference signs, unless indicated otherwise.

### DETAILED DESCRIPTION

The exemplary embodiments below, unless indicated otherwise or already indicated, comprise at least one processor and/or a storage unit in order to implement or execute the method.

Moreover, in particular a (relevant) person skilled in the art is of course aware of all routine possibilities in the conventional art for realizing products or implementation possibilities, and so in particular independent disclosure in the description is not needed. In particular, these customary realization variants known to the person skilled in the art can be realized exclusively by hardware (components) or exclusively by software (components). Alternatively and/or additionally, the person skilled in the art, within the scope of his/her expert ability, can to the greatest possible extent choose any desired combinations according to embodiments of the invention of hardware (components) and software (components) in order to implement realization variants according to embodiments of the invention.

A combination according to embodiments of the invention of hardware (components) and software (components) may occur particularly if one portion of the effects according to embodiments of the invention is brought about exclusively by means of special hardware (e.g. a processor in the form of an ASIC or FPGA) and/or another portion is brought about by means of the (processor- and/or storage-aided) software.

In particular, in view of the high number of different realization possibilities, it is impossible, nor is it helpful or necessary for the understanding of embodiments of the invention, to mention all these realization possibilities. In this respect, in particular all the exemplary embodiments below are intended to demonstrate merely by way of example some ways of showing how in particular such realizations of the teaching according to embodiments of the invention could be manifested.

Consequently, in particular the features of the individual exemplary embodiments are not restricted to the respective exemplary embodiment, but rather relate in particular to embodiments of the invention in general. Accordingly, features of one exemplary embodiment can also serve as features for another exemplary embodiment, in particular without this needing to be explicated in the respective exemplary embodiment.

FIG. 1 to FIG. 3 respectively show exemplary embodiments of the different aspects of embodiments of the invention.

In this case, FIG. 1 shows a system which is used for example to store sensor data in a network application (e.g. a distributed database system) and/or to grant access to control functions on the basis of an object. The sensor data are in particular information about an object O. The control functions are for example (digital) services which are intended to be utilized e.g. by the object or by the device. In this case, the network application comprises e.g. a databank or a database which, using reference values and/or access data, identifies and/or provides corresponding control functions on the basis of the object.

FIG. 1 shows a first node N1, a second node N2, a third node N3 and a fourth node N4, which form the nodes of the network application BC (e.g. the distributed database system realized e.g. as a blockchain), wherein one of the nodes, e.g. the first node N1, comprises the device (according to embodiments of the invention). In this case, the nodes are connected to one another e.g. via a first communication network NW1.

Furthermore, FIG. 1 shows blocks B1, for example a first block B1, a second block B2 and a third block B3, of a network application BC, wherein here in particular a segment of the network application BC is shown by way of example. In the concrete case here, the network application BC can be realized, e.g. as a blockchain or DLT.

The blocks B each comprise a plurality of transactions T. In this case, the transactions T can comprise control transactions and/or confirmation transactions and/or a data structure and/or an object data set and/or individual features.

The first block B1 comprises for example a first transaction T1a, a second transaction T1b, a third transaction T1c and a fourth transaction T1d.

The second block B2 comprises for example a fifth transaction T2a, a sixth transaction T2b, a seventh transaction T2c and an eighth transaction T2d.

The third block B3 comprises for example a ninth transaction T3a, a tenth transaction T3b, an eleventh transaction T3c and a twelfth transaction T3d.

The blocks B each additionally also comprise one of the linking checksums CRC, which is formed depending on the direct predecessor block. Consequently, the first block B1 comprises a first linking checksum CRC1 from its predecessor block, the second block B2 comprises a second linking checksum CRC2 from the first block B1, and the third block B3 comprises a third linking checksum CRC3 from the second block B2.

The respective linking checksum CRC1, CRC2, CRC3 is formed by way of the block header of the corresponding predecessor block. The linking checksums CRC can be formed using a cryptographic hash function such as e.g. SHA-256, KECCAK-256 or SHA-3. By way of example, the linking checksum can additionally be calculated by way of the data block checksum or the header comprises the data block checksum (the data block checksum is explained below).

In addition, each of the blocks can comprise a data block checksum. The latter can be realized by means of a hash tree, for example.

In order to form the hash tree, a transaction checksum (e.g. likewise a hash value) is calculated for each transaction of a data (block). Alternatively or additionally, a transaction checksum that was created by the generator of the transaction during the generation of the transaction can continue to be used for this purpose.

Usually, for a hash tree, a Merkle tree or a Patricia tree is used, for example, the root hash value/root checksum of which is stored as a corresponding data block checksum in the respective blocks.

In one variant, the data block checksum is used as the linking checksum.

A block can furthermore have a time stamp, a digital signature, a proof-of-work verification, as has been explained in the embodiments of the invention.

The network application or the blockchain BC itself is realized by a blockchain infrastructure having a plurality of blockchain nodes (nodes N1, N2, N3, N4 and further blocks). The nodes can be for example blockchain oracles or trustworthy nodes.

The nodes are communicatively connected to one another via the network NW1 (e.g. a communication network such as the Internet or an Ethernet network). By means of the network application infrastructure or the blockchain infrastructure, for example at least one portion of the data blocks B or all of the data blocks B of the network application BC is/are replicated for a portion or all of the nodes of the network application.

The device (according to embodiments of the invention) can be for example a component of the network application or in variants of a communication infrastructure (e.g. a peer-to-peer system, of a distributed communication infrastructure). By way of example, the device can communicate with other devices or databases or systems or distributed database systems by means of the network application or, in variants, they can communicate with one another by means of a communication infrastructure (e.g. a peer-to-peer system, of a distributed communication infrastructure).

The nodes of the network application (e.g. blockchain nodes) and/or the distributed database system and/or the device (according to embodiments of the invention) can for example each additionally also comprise one further component or a plurality of further components, such as, for example, a processor, a storage unit, further communication interfaces (e.g. Ethernet, WLAN, USB, fieldbus, PCI), an input device, in particular a computer keyboard or a computer mouse, and a display device (e.g. a monitor). The processor can comprise a plurality of further processors, for example, which can be used in particular for realizing further exemplary embodiments.

FIG. 2 shows by way of example the functioning of the device (according to embodiments of the invention) on the basis of a further exemplary embodiment. The device can for example also be referred to as an apparatus.

FIG. 2 shows specifically a device 100 (according to embodiments of the invention) for granting access to the control functions on the basis of an object, the control functions being for example functions of a network application, of the device or of the object O.

A node from FIG. 1 can e.g. comprise the device 100 or be embodied as the device 100 or a node from FIG. 1 is connected to the device 100 via a data line or a communication network.

The device 100, for granting access to control functions on the basis of an object, comprises a capture module 110, a checking module 120, a control module 130 and a communication module (e.g. a network interface) 101, which are communicatively connected to one another via a bus (e.g. a PCI bus, CAN bus, USB or data line) 102.

The device 100 optionally comprises a processor and/or a cryptography module and/or a calculation module and/or a protection module, which, optionally or if present, are likewise communicatively connected to one another via the bus (e.g. a PCI bus, CAN bus, USB or data line) 102.

The capture module 110 is designed for capturing individual features M (these individual features can e.g. also be referred to as object-specific features) of the object O by means of a capture device A. For this purpose, the capture device A is connected via a data connection (wireless or wired) (e.g. with USB, LAN, W-LAN, Bluetooth, Firewire) C to the capture device A. By way of example, by means of a scanning beam, the capture device A captures/measures surface unevennesses as individual features for the object O and transfers (S11) the individual features to the capture module 110.

The checking module 120 is designed for calculating a check result on the basis of comparing the individual features with a reference value.

The control module 130 is designed for granting access to the control functions, wherein the access to the control functions is effected depending on the check result (S1) if the check result confirms a sufficiently accurate match between the reference value and the individual features.

The control functions F (e.g. a first control function F1, a second control function F2 and a third control function F3) are for example (digital) services which are intended to be utilized e.g. by the object or by the device. The checking module 120 and/or the control module 130 are/is used for example to identify what control functions are relevant to the object O or are intended to be utilized on the basis of the object. Alternatively or additionally, the object O or the device or a user of the device issues a request for corresponding control functions to the device (or a network application) via a corresponding communication connection.

On the basis of the individual features and/or on the basis of the reference value, the device can identify e.g. the corresponding control functions.

A network application (e.g. the network application from FIG. 1 or a Cloud CL) or a database can in this case comprise a multiplicity of reference values, for example, to which e.g. the corresponding (allowed) control functions (e.g. write functions and/or access restrictions) for a corresponding object are assigned. By way of example, which of the control functions are available or can be provided when the object is present is identified by means of comparing and determining the check result on the basis of the individual features with the reference value. Alternatively, the corresponding control functions can be identified or selected by way of a request issued e.g. by the object or by the device or by a user.

In this context, providing means, for example, that the control functions assigned to the object or to the corresponding reference value are accessed by e.g. communication of access data corresponding to the device and/or to the object and/or to the network application for the control functions (e.g. a web service) (e.g. via a communication connection). The access data are usable in a time restricted manner in order to ensure that these data cannot be used for an unnecessary long period of time e.g. in the absence of the object.

In this case, the check result confirms for example a sufficiently accurate match between the reference value and the individual features.

If the check result is negative—the sufficient match between the reference value and the individual features is not confirmed—then the access to the control functions is prevented or not given.

The reference value can be for example a key for an entry in an assignment table (e.g. hash table) or a database, wherein for a key or reference value there is stored in each case corresponding information or a data set with corresponding information indicating which control functions are available for the corresponding reference value.

If e.g. the individual features are then captured, in the course of comparing e.g. a check is made to ascertain whether, for the corresponding individual features, there exists an associated key (reference value) for an entry with a data set with corresponding information about control functions in the hash table or in the database. Accordingly, checking the individual features with the reference value can be checking for the presence of a key (reference value) for a corresponding entry with information about control functions.

If no entry can be identified or assigned, for example, no corresponding control functions are identified, for example, and e.g. an error message can be output.

As already explained, the intention, e.g. by way of the device, is for access to control functions to be given in the case of a sufficient match between the individual features and the reference value. The corresponding control functions to which access is intended to be given (e.g. the first control function F1 and the second control function F2) can be identified e.g. by way of the individual features and/or reference value and/or by way of a request (e.g. by the object, by a user of the device or by the device itself). Alternatively, it may e.g. also be the case that the corresponding control functions do not even have to be identified or selected in the first place, since e.g. upon each request or use in each case the same control functions are provided (control functions F1-F3) and in particular a check is intended to be made here to ascertain whether e.g. a matching object or an object that corresponds to the reference values is present.

In further variants, the reference value can be e.g. a number sequence of a plurality of reference values or, instead of the reference value, a plurality of reference values are used during comparing.

In the course of comparing or checking the individual features, by way of example, it is possible to take account of tolerance values in order e.g. to take account of measurement inaccuracies of the capture device A.

Analogously to the captured individual features, the reference value can also be present as a hash value, for example, which was calculated by means of a one-way function, for example.

In this case, it is advantageous that the corresponding features or values are present only indirectly and thus cannot straightforwardly be copied nor can a counterfeit object be created without e.g. having access to the original object O in the process.

The communication with the object O and/or the Cloud CL and/or the network application and/or the database is effected here via the communication module (e.g. a network interface) 101.

Once the communication connection has been established, various computer-controlled operations can be performed.

By way of example, the control functions can allow access to the network application (e.g. the Cloud CL) in order to exchange or synchronize data about the object in a data structure with the database or the network application. For this purpose, by way of example, corresponding control functions F of the Cloud CL can be used in order e.g. to store the corresponding data (e.g. state data about the object or measurement data about the object) in the Cloud or at some other location. Alternatively or additionally, by means of the control functions, it is possible to carry out maintenance work on the object O by a firmware update or a software update or an update of configuration files or an update of access authorizations for the object being performed e.g. by way of a corresponding control function of the control functions.

For example, by means of the control functions, it is possible to control parts of a technical installation (e.g. a manufacturing installation) for the object O. This can be the control of a conveyor belt, for example, in order that the object O (e.g. a melting furnace) is supplied with material for melting or the object O (e.g. a manufacturing robot) is supplied with the next part to be manufactured.

The corresponding control functions can be realized for example as a smart contract of the network application.

The optional calculation module is designed for calculating an object-specific characteristic on the basis of the individual features M. When calculating the object-specific characteristic, it is possible to take account of tolerance values, for example, in order e.g. to take account of measurement inaccuracies of the capture device A during the below-mentioned determination of the first cryptographic key. The calculation module can be dispensed with for example in implementation variants in which the cryptographic key is provided on the basis of the individual features.

The optional cryptography module is designed for providing a first cryptographic key on the basis of the individual features and/or the object-specific characteristic.

In one variant, the optional cryptography module can calculate for example a first cryptographic key on the basis of an object-specific characteristic and/or on the basis of the individual features.

In one variant, the individual features are compared with the corresponding reference value (e.g. by the cryptography module), wherein in the case of a sufficiently accurate match between the reference value and the individual features, the first cryptographic key and/or access data are/is released by the cryptography module or control module.

By way of example, the access to the corresponding control functions is effected using the first cryptographic key and/or by means of the access data. Preventing access (e.g. if the individual features do not sufficiently match the reference values) to the control functions can be realized e.g. by preventing access to the first cryptographic key and/or to the access data.

In this case, providing the first cryptographic key or the access data can be realized in various ways, for example. By way of example, the individual features and/or the object-specific characteristic can be compared with reference values or a reference value, corresponding tolerance values being taken into account here, for example. If the individual features and/or the object-specific characteristic match(es) the reference value (e.g. after taking account of the tolerance values), then the first cryptographic key and/or the access data are/is loaded e.g. from a secure data memory. The reference value can be captured or stored for example during an initialization phase and/or installation phase of the device. The initialization phase and/or installation phase for the device can be implemented only once.

Alternatively, the first cryptographic key or the access data is/are calculated on the basis of the individual features and/or the object-specific characteristic by the individual features and/or the object-specific characteristic being used as input data for a key derivation function. Even further data can also be used in this case (e.g. a stored user name). By way of example, a character string (e.g. a secret password) can be linked with the individual features and/or the object-specific characteristic, in which case for example, these linked data are then used to calculate the first cryptographic key or the access data (e.g. a password for a user name, with the user name being stored in the device, for example) by means of a key derivation function (e.g. PBKDF2),

In one variant, the communication connection is protected by means of cryptographic protection.

In one variant, the cryptographic protection can be generated and/or checked and/or removed with the first cryptographic key and/or the access data.

By way of example, the communication connection can be a secure communication connection, in the case of which the object O and the Cloud CL each require a cryptographic key in order to establish the secure communication connection. In this case, by way of example, the reference value or the reference values or a derived value therefrom (e.g., by means of a hash function or key derivation function) can serve as a cryptographic key for the secured communication connection for the Cloud CL (or the network application). As a result, e.g., corresponding reference values are managed by the Cloud CL or by the network application.

The individual features or a derived value therefrom (e.g., by means of a hash function or key derivation function) can serve as a cryptographic key or as access data for the secured communication connection for the object O.

A data structure protected by means of a cryptographic checksum can be used for a data exchange between the object O and the Cloud CL. The data structure and the cryptographic checksum are stored in a data set, for example, wherein the data set is stored for example as a transaction in the distributed database system or the network application. For this purpose, the transaction can comprise an additional checksum (e.g., a transaction checksum), which was generated e.g. by means of a cryptographic key (e.g. a private cryptographic key) that is assigned to an entity or is used by the latter. The entity can be for example an operator of a measuring station or processing station by which the object O is controlled, processed or managed. The data set can also be a message or transaction, depending on the implementation, for example.

Depending on the implementation variant, the data structure can e.g. also correspond to the data set if e.g. the data structure comprises a data field for storing the cryptographic checksum or the cryptographic checksum is appended to the data structure. As already explained, in particular the data structure and/or the data set can be stored or comprised by a message or a transaction. Alternatively, for example, the data structure and/or the data set can be a message or a transaction.

In a further variant, the optional protection module is designed for cryptographically protecting the data structure by means of the cryptographic checksum, wherein the protection module calculates the cryptographic checksum by means of the first cryptographic key. In this case, the cryptographic checksum can be calculated for example using a keyed hash message authentication code (HMAC, e.g., using MD5, SHA1, SHA256). In further implementation variants, the cryptographic checksum can be realized as a digital signature or as a digital certificate, in which case, depending on the cryptographic methods used (symmetric or asymmetric methods), the first cryptographic key functions for example as a private key in order to generate the digital signature. For the purpose of checking the digital signature, for example, the public key is derived from the first cryptographic key and provided by a trustworthy entity (e.g., a trustworthy server), and so, in variants, a checking entity can access the corresponding key, for example. If the private key has e.g., been generated and e.g. been stored in a memory of the cryptography module, for example the corresponding individual features of the object can be changed or made unusable, such that the first cryptographic key can no longer be derived. This can be done for example by a procedure in which, in the case of surface features, the corresponding position on the surface of the object is polished, colors/particles are washed off the object (e.g., by means of solvents) or colors/particles are additionally applied to the object in order to make the corresponding individual features unusable or to change them. By way of example, it is also possible for the individual features to be made unusable in such a way that the first cryptographic key can no longer be calculated directly on the basis thereof but, taking account of tolerance values, the object-specific characteristic can still be calculated on the basis of the changed individual features in order e.g. to provide or calculate the public key by means of the cryptography module.

Alternatively or additionally, in a further variant, the public key can be a (digital) fingerprint, the digital fingerprint being formed on the basis of the individual features. The individual features (e.g. surface unevennesses, a dye with a specific spectrum, which decays after a predefined time, for example, in order in particular thus to encode a shelf life) can in this case be incorporated/introduced into the object or be applied to the object. This fingerprint or the individual features cannot be ascertained/read for example with the naked eye and/or without knowledge of the type and position or can be ascertained only with considerable technical outlay. Accordingly, by way of example, the information (e.g. the object data set) for capturing the individual features can be stored in a protected memory of the device, such that this information cannot be accessed by unauthorized persons. The incorporated fingerprint/individual features can be for example surface unevennesses produced during the manufacture of the object or the further processing of the object. Alternatively or additionally, in a further variant, the fingerprint can be realized by applying colors or particles, wherein for example the colors or particles are applied in such a way that an individual spectrum is generated for the object. For this purpose, by way of example, different colors/particles can be distributed over the surface of the object, such that for example a geometric spectrum is generated in order that a predefined spectrum can be measured e.g. at specific positions of the object. The spectrum or the colors/particles are chosen for example in such a way that they do not lie in the spectrum that is visible to the human eye. This can be for example a spectrum that lies beyond 800 nm.

The use of tolerance values is advantageous e.g. to the effect of, for example, taking account of (or compensating for) measurement inaccuracies when calculating the characteristic or capturing the individual features, in order to calculate the object-specific characteristic or the individual features for the correct object, optionally in a reproducible manner.

By way of example, in a further variant, the tolerance values can be chosen in such a way that, in the case of spectroscopic individual features of an object, e.g. in the form of food, no first cryptographic key is provided (or no valid first cryptographic key can be provided) if the object or the food is no longer fresh enough. By way of example, if the object is bananas, then the tolerance value for the spectrum of the surfaces of the bananas can be chosen in such a way that when the bananas turn brown over a large area no first cryptographic key is provided (or no valid first cryptographic key can be provided) for these bananas or is generated. Accordingly, at a transport point or at an intermediary, the bananas or a banana delivery with these bananas can no longer be confirmed/stored as “fresh” in a supply chain by means of a message with the data structure or the data structure in the distributed database system. In the same way, for example, other objects in the form of perishable goods can be monitored by means of messages/data structures in a distributed database system, in a further variant. The corresponding tolerance values are then chosen accordingly so that, if appropriate, no first cryptographic key is provided if the perishable goods have degenerated e.g. too much (e.g. the shelf life of food has expired or the food has spoiled). Alternatively, if the tolerance values are exceeded, for example, an alternative cryptographic key can be provided, on the basis of which it is possible to test the point in the documentation of the transport of the object at which the tolerance values were exceeded.

Accordingly, the stated tolerance values can be used not only in the case of the object-specific characteristic, but likewise can be used if the first cryptographic key is intended to be provided on the basis of the individual features. This may be necessary for example if the individual features (which can also be referred to as object-specific features) are intended to be compared with a reference value in order to release the first cryptographic key in the case of a corresponding match or the individual features are intended to serve as input parameters for a key derivation function and e.g. errors with regard to a reproducible key derivation owing to measurement inaccuracies are intended to be prevented.

Embodiments of the invention can be used advantageously in supply chain management or when monitoring a supply chain, for example. Particularly if, for example, during transport of objects (e.g. goods such as food, electronic components, precious parts, etc.), object-related data from the different entities (e.g. manufacturer, a plurality of logistics companies, sales, buyers) involved in the production, transport or selling of the object, for example, are generated at different points in the processing/handling of the object and/or at different times for documentation reasons. In this case, embodiments of the invention are advantageous in particular if the entities involved do not trust one another, since the corresponding data are protected e.g. by the cryptographic checksum and/or a checksum of a corresponding entity. The device can be for example part of a transport container for transporting e.g. food such as bananas or milk, or there are a plurality of devices of identical type at the different points in the processing/handling of the object or the times when this takes place.

By way of example, at a processing location (e.g. handover of the object to the logistics company), object-specific data (e.g. the nature of the object, type, manufacturer, unique identifier/UID, etc., time of arrival at the logistics company) are captured and stored in an object data set or documentation data set and are intended to be stored e.g. in the network application. The object data set/documentation data set can then be stored in the data structure e.g. for storage in the network application and, as already explained, can be protected e.g. with the cryptographic checksum by virtue of the first cryptographic key being provided in accordance with the explanations.

By using the individual features for providing the first cryptographic key or the access data, it is possible for a corresponding object, in particular a physical object, to be linked to a greater degree by means of the “digital world”. By way of example, if the object is transported for an excessively long time or is changed by the processing/handling/transport in such a way that e.g. the corresponding tolerance values are no longer complied with, the exceedance of the tolerance values or improper treatment of the object can be verified without interruptions. Moreover, it is possible in this case to verify whether the object was replaced by another object, for example, which is relevant in the case of product counterfeiting, for example.

If the object were now replaced by a counterfeit object, the corresponding individual features would change. This may be relevant to medical products, for example, in order to find out whether, in the case of a silicone implant, for example, the latter is actually a manufacturer's silicone implant rather than an implant that has been counterfeited. For this purpose, e.g. during the production of the object (implant), the corresponding data for the object are written to the distributed database system according to one of the variants mentioned above. Logistics companies, sales companies and clinics that transport, trade and implant the object document the corresponding processing steps carried out by them, times and further relevant data (indications concerning the respective entity), in each case according to the aforementioned method. The individual features of an implant can be for example surface features of the implant (e.g. surface of the silicone pad or the surface of a metallic implant). In the case of the silicone pad, for example, the individual features can also be a measured spectrum of the content (silicone) of the silicone pad. Embodiments of the invention are not restricted only to silicone pads. Other implants with other fillings can likewise be checked as well. Moreover, it is thereby possible to determine the authenticity of other medical products such as medicaments (e.g. by way of spectra) or medical devices such as Mills, CTs and their electronic components (e.g. by means of test signals or noise signals).

Moreover, the device can use different individual features, the individual features encoding a predefined key (e.g. as a fingerprint). The different individual features are then situated e.g. at different randomly selected, positions on the object. These positions can optionally be stored in an object data set.

Alternatively, it is possible for the individual features not to be defined randomly, but rather to be situated, in the case of a corresponding object, at a known/allocated position (e.g. on the base of the object or on uneven regions of a workpiece).

FIG. 3 shows a further exemplary embodiment of the invention, illustrated as a flow diagram for a method.

The method is realized in a computer-implemented manner.

Specifically, a method for granting the access to the control functions on the basis of an object is explained in this exemplary embodiment.

The method comprises a first method step 310 for capturing individual features of an object by means of a capture device.

The method comprises a second method step 320 for calculating a check result on the basis of comparing the individual features with a reference value.

The method comprises a third method step 330 for granting access to control functions, wherein the access to the control functions is effected depending on the check result if the check result confirms a sufficiently accurate match between the reference value and the individual features.

A further exemplary embodiment of the invention, not shown in a figure, relates to a method for the computer-aided checking of a cryptographic checksum.

Embodiments of the invention relate to an ecosystem of devices which interact with one another autonomously by means of a blockchain or network application. In particular, security-protected data processing of sensor data or measurement data for an object is realized by means of embodiments of the invention with a distributed infrastructure (e.g. the network application). Fields of application here are supply chain scenarios or industrial control applications of blockchains.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

[1]

### Andreas M. Antonopoulos “Mastering Bitcoin: Unlocking Digital Cryptocurrencies”, O'Reilly Media, December 2014

[2]
Roger M. Needham, Michael D. Schroeder “Using encryption for authentication in large networks of computers” ACM: Communications of the ACM. volume 21, No. 12 Dec. 1978,
[3]
Ross Anderson “Security Engineering. A Guide to Building Dependable Distributed Systems” Wiley, 2001
[4]

### Henning Diedrich “Ethereum: Blockchains, Digital Assets, Smart Contracts, Decentralized Autonomous Organizations”, CreateSpace Independent Publishing Platform, 2016

[5]
“The Ethereum Book Project/Mastering Ethereum” https://github.com/ethereumbook/ethereumbook, as on Oct. 5, 2017
[6]

### Leemon Baird

### “The Swirlds Hashgraph Consensus Algorithm: Fair, Fast, Byzantine Fault Tolerance”, Swirlds Tech Report SWIRLDS-TR-2016-01, May 31, 2016

[7]

### Leemon Baird

### “Overview of Swirlds Hashgraph”,

### May 31, 2016

[8]

### Blockchain Oracles

https:blockchainhub.net/blockchain-oracles/

1. A device for granting access to control functions on the basis of an object, comprising:
a capture module for capturing individual features of an object by means of a capture device;
a checking module for calculating a check result on the basis of comparing the individual features with a reference value;
a control module for granting access to control functions, wherein
the access to the control functions is effected depending on the check result if the check result confirms a sufficiently accurate match between the reference value and the individual features.

2. The device as claimed in claim 1, wherein
the device includes a cryptography module,
the cryptography module calculates a first cryptographic key on the basis of an object-specific characteristic and/or on the basis of the individual features.

3. The device as claimed in claim 1, wherein
the individual features are compared with the corresponding reference value,
in the case of a sufficiently accurate match between the reference value and the individual features, the first cryptographic key and/or access data are/is released by the cryptography module or control module,
the access to the corresponding control functions is effected by way of the first cryptographic key and/or by means of the access data.

4. The device as claimed in claim 1, wherein
a communication connection is set up between the object and/or the device, or
a communication connection is set up between the object and/or a network application, or
a communication connection is set up between the object and/or the device and/or a network application.

5. The device as claimed in claim 1, wherein
the communication connection is protected by means of a cryptographic protection.

6. The device as claimed in claim 2, wherein
the cryptographic protection is generated, checked or removed with the first cryptographic key.

7. The device as claimed in claim 1, wherein
the reference value is a reference hash value or a unique identifier which was formed for a/the stored reference value,
the object-specific features are an object hash value or a unique identifier which was or is formed during capture of the object-specific features.

8. The device as claimed in claim 1, wherein
the reference value is defined during production of the object,
the reference value is assigned to the object during production thereof.

9. The device as claimed in claim 1, wherein
the control functions allow access to a database or network application in order to exchange or synchronize data about the object in a data structure with the database or the network application.

10. The device as claimed in claim 1, wherein
the control functions are corresponding control functions of the device and/or corresponding control functions of the object and/or corresponding control functions of a network application.

11. The device as claimed in claim 1, wherein
the network application or the distributed database system is a blockchain,
the device is embodied as a node or an oracle of the distributed database system or of the network application,
the cryptographic checksum is a digital signature.

12. The device as claimed in claim 1, wherein
the device comprises a calculation module,
the calculation module is designed for calculating an object-specific characteristic on the basis of the individual features,
the characteristic is calculated taking account of predefined tolerance values of the individual features,
the characteristic and/or the individual features are/is compared with the corresponding reference value,
in the case of a sufficiently accurate match between the reference value and the characteristic and/or the individual features, the first cryptographic key is released by the cryptography module,
the device comprises a monitoring module,
the monitoring module is designed to monitor the device and to store information of the monitoring in a file or in a data structure.

13. The device as claimed in claim 1, wherein
the object and/or the device comprise(s) an object data set,
the object data set indicates at what geometric locations and/or interfaces the capture device can capture the individual features,
the object data set comprises the individual features and/or the object-specific characteristic in encrypted form,
the encrypted individual features and/or object-specific characteristic can be decrypted by means of the first cryptographic key,
the object data set comprises further object data such as, for example, measurement values of the object, measurement values about the object, production indications of the object, whereabouts of the object,
the further object data are captured by sensors of the device for the object,
the sensors are a GPS module and/or temperature sensors and/or optical sensors which capture corresponding properties of the object.

14. A computer-implemented method for granting access to control functions on the basis of an object, comprising the following method steps:
capturing individual features of an object by means of a capture device;
calculating a check result on the basis of comparing the individual features with a reference value,
granting access to control functions, wherein
the access to the control functions is effected depending on the check result if the check result confirms a sufficiently accurate match between the reference value and the individual features.

15. A computer program product comprising a computer readable hardware storage device having computer readable program code stored therein, said program code executable by a processor of a computer system to implement a method comprising program instructions for carrying out the method as claimed in claim 14.

16. A providing apparatus for the computer program product as claimed in claim 15, wherein the computer program product is stored and/or provided by the providing apparatus.
